(19) United States
(12) Patent Application Publication
(10) Pub. No.: US 2008/0253222 A1
(43) Pub. Date: Oct. 16, 2008

(54) Machine for Dosing and Mixing Liquid Products and Operating Method Thereof

(75) Inventor: Ricardo Verdu Alvaro, Paiporta (ES)

Correspondence Address: BROWN & MICHAELS, PC;400 M & T BANK BUILDING, 118 NORTH TIOGA ST, ITHACA, NY, 14850, US

(73) Assignee: VALVER AIR SPEED, S.L., Paiporta (ES)

(21) Appl. No.: 12/089,585

(22) PCT Filed: Nov. 27, 2006
(86) PCT No.: PCT/ES2006/000654

§ 371 Date: Apr. 8, 2008

(30) Foreign Application Priority Data
Nov. 29, 2005 (ES) ES200502624

(51) Int. Cl. B01F 15/02

(52) U.S. Cl. 366/132

(57) ABSTRACT

The present dosing and mixing machine for liquid products and its operation system is intended for dosing, mixing, and homogenizing any liquid products regardless of their nature and application, that can operate either statically or dynamically, that includes a tank (4) with a lid (10), which has an agitator (8), with an axis with helixes (14) whose height can be adjusted, constituted by a chassis (1) provided with a control device (2) with an electronic doser that is formed by a robot and some peripheral devices that allow selecting the operation modes of the machine, and incorporates a cleaning pump and a tank for smaller volume mixes (4); an in-built viscosity regulator, and a set of electronically controlled dosing pumps (5) with intakes that allow the direct suctioning from the intake tank (7).

### PURPOSE OF THE INVENTION

The present invention refers to a new dosing and mixing machine for liquid products and its operation method, whose purpose lies in having a configuration that allows dosing and mixing at the same time, as well as the homogenization of any liquid product regardless of its nature or final destination and its consequent application in any production or consumption process; as well as dosing and mixing of components, where percentages or ratios are selected directly on the machine dashboard, which has a limited number of possibilities.

This invention can be used in the industry that produces gadgets, devices and elements for dosing and mixing liquid products in general.

### BACKGROUND OF THE INVENTION

The applicant, after having researched the field, has no knowledge of the current existence of any mechanized dosing and mixing systems for liquid products in general with similar characteristics to those of the machine herein advocated, with the exception of the machine corresponding to invention patent P 200201012, belonging to the same author, that describes a dosing and mixing machine for liquids whose characteristics are remarkably inferior in comparison to the characteristics of the machine described in this document.

### DESCRIPTION OF THE INVENTION

The dosing and mixing machine for liquid products and its operation method proposed by this invention is configured as a machine that is capable of automatically dosing and at the same time mixing several liquid components over which a ratio or portion control is desired. More specifically, the dosing and mixing machine for liquid products in general has control electronic means that are in-built in the structure itself, acting as an electronic control over all flow regulation means, dosing the appropriate volume of each component to obtain the desired final mixture.

Dosing can be carried out with any type of liquid, regardless of its being conductor or not, which eliminates the dependence on temperature or fluid regime.

The dosing and mixing machine for liquid products in general has an electronic doser whose main function is to achieve a given and accurate ratio between the different liquid components forming the mix to obtain, liquids being placed in the dose meter inputs or being directly suctioned by the dose meter or indirectly choked by another pump.

The hose that carries the liquid feeds the dosing pump, which creates vacuum as the liquid flows, causing the inner cavity of the pump to be filled with liquid, and when flowing in the opposite direction the valve system causes the liquid to be expelled from the cavity following a path that is different from the suction path. This dosing of the liquid volume is considered as a stroke, a total run from the maximum opening position of the diversion pump, filling the cavity to its maximum level, up to the position that control electronics or electro-pneumatics indicate.

Ratio management is carried out by means of different dosing pumps, controlling the dosed volume for each pump in reference to that of the main pump, thus creating a volumetric ratio that ensures proportionality.

An automatic reload system can be added for intake tanks so that when these tanks are emptied, they can be re-filled up to a preset level.

Control electronics determines the maximum displacement, or cycles, for each of the pumps for the selected mixing ratio of components, with a common initial position and a fixed final position for one of them and variable for all the rest, which allows selecting different ratios with respect to a fixed volume.

Doser control electronics consists of a robot accompanied by different peripherals to manage data input or orders and the outputs that will activate the electro-valves and other elements for machine operation.

The dosing machine also has the capability of controlling the minimum levels that allow repeating the dosing cycle and security levels to prevent an overflow of the mix, in the event that the control mechanisms fail.

The invention has mechanisms to trigger an alarm warning in case of room temperature changes, since there are processes for which it is advisable to take measures in case of changes in temperature; it will be possible to set the tolerable increase and monitoring will be permanent.

### DESCRIPTION OF DRAWINGS

As a complement to the description herein included, and in order to help achieve a better understanding of the characteristics of the invention, this descriptive report is accompanied by a series of figures that are part of the present descriptive report. These figures represent the following aspects, but are illustrative rather than restrictive:

FIG. 1.—Representation of the front view of the invention corresponding to a dosing and mixing machine for liquid products in general.

FIG. 2.—Mixing element used to dynamically mix the liquids.

FIG. 3.—Cross-section of the tank shown in FIG. 2.

FIG. 4.—Spiral and chamber for static mixing.

### PREFERRED DEVELOPMENT OF THE INVENTION

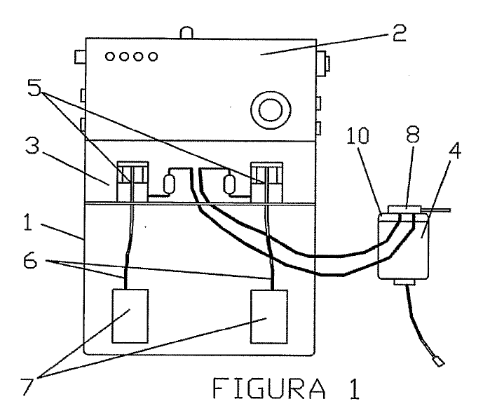

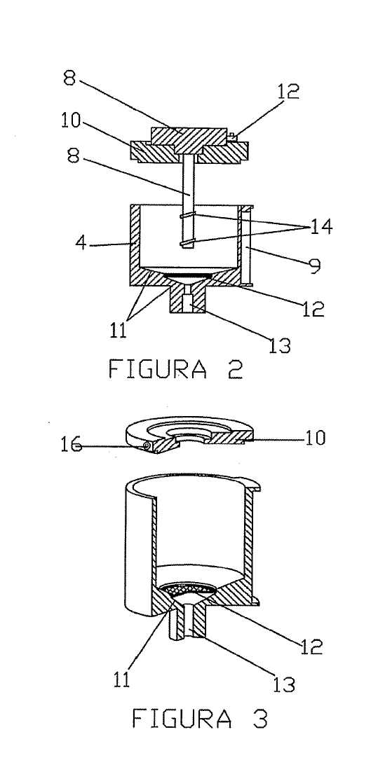

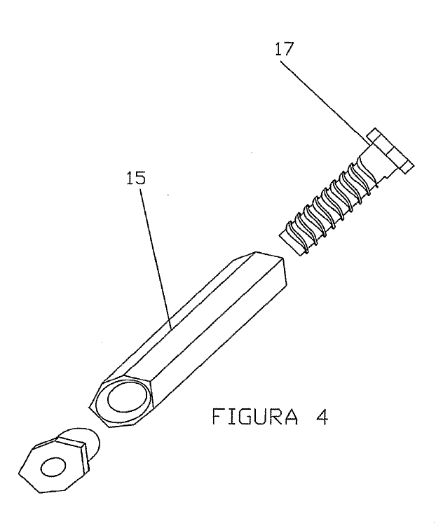

FIG. 1 shows how the dosing and mixing machine for liquid products in general is formed by a chassis or structure (1) upon which the inclusion of a dashboard (2) has been planned, a module with the dosing pumps (3) and a mixing tank (4) with an agitator.

The invention presents the corresponding piping and entry ways to the machine, as well as a cleaning pump that allows introducing the cleaning product either manually or automatically. It has the aforementioned agitator (8) with a double helix (14) to properly mix the fluids, as well as a tank (4) where smaller amounts of mixes can be prepared.

It can be seen that the mixes obtained are incorporated in a tank (4) provided with a lid (10) with an agitator, which has a conic lower shape (11) where a filter (12) has been placed to fully use the mix obtained, with no impurity generating residue.

In order to use the dosing and mixing machine, the user will set the mixing ratio electronically and variably by means of a mechanical selector or directly at the electronic selection system, from 100% to 1%, being able to select different percentages as desired.

The monitoring system that controls the correct operation of the system as regards the mixed product obtained is monitored by means of a weighing system installed in the mix tank support, which allows verifying that the product that leaves each pump of the dosing system (3) reaches the mixing tank (4); in order to control that the real result of fluids proportion is complying with the specified ratio there is a monitoring system that controls intake tanks (7) where the remaining volume of each media is known at all times, which allows verifying that the fluid ratio in the mix is correct.

The program mode for the mix can be selected by the user, either by parts or by percentage.

The mix is done in a technical plastic tank (4) with a lower intake (13) provided with a filter (12) put in a conical base that allows a complete suctioning and minimizes the production of residues, and which has a double helix (14) agitator (8) for seamless homogenization.

A viscosity regulation system is added—once the viscosity of the resulting mix is preset, the system keeps it constant by automatically adding diluting agent or increasing resin and mixing components temperature if needed.

The invention will dose a mixing volume that should be poured into tank (4) for each loading operation; when the mix reaches the minimum preset level, the doser will automatically re-fill it with the minimum mix volume or the preset volume, this process being repetitive.

Once the mixing volume is dosed, when reached, the machine stops to limit the consumption of mix strictly to the speed required for the production process, since the machine will not start again for a new dose until the minimum level is detected.

The invention also allows establishing a curing time, if the mix requires it, being the user able to set a maximum time of permanence for the mix in the tank, so that if this set time passes before the minimum level of the tank (4) is reached, a light and sound alarm will be triggered to warn the user that the tank and the rest of the machines with mix product that is about to expire should be cleaned to avoid any kind of problem in the production process.

The invention also has the means for automatic clean-up, so in this case the sound alarm would indicate that this option, carried out by means of electro-valves and pneumatic pilot keys, will be started.

The invention offers the possibility of programming a time alarm that allows setting up from one to several shifts as needed so that the light and sound alarm is triggered before the end of the working day.

This machine mixes products either dynamically or statically, that is, dynamically by using the tank (4) where the number of selected products are dosed and mixed by means of an agitator (8) anchored to the lid (10) of the tank; this agitator can be set to continuously stir the mix or to do so only during the dosing stage. The aforementioned tank lid (10) is provided with hose connections (16) coming from the doser.

Statically, the mixing process is done by means of a spiral (17) made of aluminum, stainless steel, polyethylene, or any other suitable material, that is introduced in a perimeter-adjusted chamber (15) so that fluids that converge in it trace a labyrinth-like path, from entry to exit, with holes and wings, elevations and depressions, that cause the liquids to mix and form the final mixture.

When products are mixed dynamically, a tank (4) is used, where an agitator (8) anchored to the lid (10) and the hoses coming from the doser (5) are introduced; thus, the different products to mix are poured into the body of the tank (4) that is capable of controlling the level of the fluids by means of an electronic control installed in the cavity (9) of the tank (4) so that upon detection of the minimum preset level, the dosing and stirring procedure is repeated in order to achieve a constant feed for the production process. This level control system also warns the user when the mix in the tank (4) might overflow due to operation failure.

The invention has an operation monitoring system for fluid dosing pumps that allows detecting if a pump is operating under no load and triggers an alarm to let the user know that a replenishment operation is needed or that one of the dosing pumps is malfunctioning—upon detection of any of these problems, a light and sound alarm would be triggered.

The device triggers a light and sound signal to indicate the occurrence of an alarm, it is possible to locate it at a distance, and it can also be a completely autonomous system, with no wires, self-fed and operated via remote control.

It should also be mentioned that the height of both helixes (14)—in-built onto the agitator (8) axis—can be adjusted, which makes stirring the mixture from the beginning of the dosing process easier.

Once finished, the mixture will be transported to the production process, which can be done by the action of gravity—by incorporating an exit orifice at the bottom (13) or on the side of the tank—or by suction using any type of pump that is suitable for suctioning the mixture.

After the dosing and agitation of the desired products is obtained, the new product has to be incorporated to the production process, which can be done using any equipment as required by the application just by connecting it to the mixing tank (4) outlet (13).

Having described the nature of the present invention and its practical application in detail, all that remains to be mentioned is that its shape, materials, as well as its fabrication, can be modified as long as they do not substantially affect the characteristics that are claimed in the following section.

1. Dosing and mixing machine for liquid products and its operation system, for dosing, mixing, and homogenizing any liquid products regardless of their nature, final destination and application, that can operate either statically or dynamically, that includes a tank (4) with a lid (10), which has an agitator (8), with an axis with helixes (14) whose height can be adjusted, characterized for having a structure, chassis or framework (1) provided with a control module (2) with an electronic dosing control that is formed by a robot and a series of peripheral devices that allow selecting the operation modes of the machine and operate the different electro-valves that allow operation, with the possibility of adding a cleaning pump and a tank for reduced-volume mixtures; an in-built viscosity regulator, the possibility of coupling a remote control or monitoring and error management device for the machine, which in turn has a set of electronically controlled dosing pumps (5) with intakes that allow a direct suction from the intake tank (7) with the dosing pump, driving the fluids to mix directly to the mixing tank (4), flow regulation being controlled by the dosing pump (5) where the hose (6) that drives the liquid feeds this pump (5), which creates vacuum with its movement to cause the inner cavity of the pump to fill with liquid and, when moving in the opposite direction, and thanks to its valve system, makes the liquid to be expelled from the cavity in the direction opposite to the suctioning direction; this machine can also incorporate a control system that triggers room temperature variation warnings, as well as an application viscosity regulation system and a machine running timer.

2. The dosing and mixing machine for liquid products and its operation method, of claim 1, in which the intake tanks (7) have the means to carry a product level monitoring system and can add means to reload these intake tanks (7) when they become empty or when they reach a preset level, triggering an alarm warning.

3. The dosing and mixing machine for liquid products and its operation method, of claim 1, further comprising a machine operation monitoring system by means of a continuous weighing system installed in the mixture tank (4) support.

4. The dosing and mixing machine for liquid products and its operation method, of claim 1, in which the dosage of a liquid volume is determined by a total run from the maximum opening position of the dosing pump (5), fill-up of the cavity up to its maximum level, up to the mark indicated by control electro-pneumatics.

5. The dosing g and mixing machine for liquid products and its operation method, of claim 1, in which, when, the cavity of pump (5) is filled, a sensor warns that the pump has reached the end of the upper run, so that the electronic control allows air to enter into the upper cavity to displace the pump downwards and create an excess of pressure in the lower cavity, thus causing the opening of exit valves and the emptying of the cavity.

6. The dosing and mixing machine for liquid products and its operation method, of claim 1, in which, when, the cavity of the pump (5) is empty, a sensor warns that the dosing pump has reached the end of the lower run, and the electronic control switches the entry air feed to escape to cause vacuum and the consequent re-fill with product.

7. The dosing and mixing machine for liquid products and its operation method, of claim 1, in which the hoses that come from the doser (5) incorporate the different products to mix inside the tank (4), which controls liquid level by means of an electronic control installed in the tank (4) cavity (9), with a level control that warns about the possibility of mix overflow from the tank (4) due to operation malfunction.
